(19) United States
(12) Patent Application Publication
(10) Pub. No.: US 2024/0065164 A1
(43) Pub. Date: Feb. 29, 2024

(54) Stalky Crop Harvesting System and Process

(71) Applicant: Formation Ag International , LLC, Monte Vista, CO (US)

(72) Inventor: Corbett Hefner, Monte Vista, CO (US)

(21) Appl. No.: 18/237,520

(22) Filed: Aug. 24, 2023

Related U.S. Application Data
(60) Provisional application No. 63/373,524, filed on Aug. 25, 2022.

(51) Int. Cl. A01D 57/20; A01D 34/24; A01D 47/00; A01D 57/02; A01D 57/22; A01D 61/00; A01D 61/02

(52) U.S. Cl. CPC A01D 57/20; A01D 34/24; A01D 47/00; A01D 57/02; A01D 57/22; A01D 61/004; A01D 61/008; A01D 61/02; A01D 34/04

(57) ABSTRACT

A harvesting system for harvesting stalky plants is mountable on a power unit such as an agricultural combine. The harvesting system may have both an upper harvesting head that cuts off the tops of the plants and the directs seed-bearing portions of the plant to the combine's thresher, and a lower harvesting head cuts the stalks near the ground and discharges the stalks in two or more windrows. In order to increase throughput, the upper harvesting head may be raisable and lowerable relative to the combine's feeder housing. To accommodate such adjustment, a discharge conveyor of the upper harvesting head may extend at an adjustable angle relative to the feeder housing. The lower harvesting head may have draper belts arranged to discharge the stalks in two or more, and more typically three or more, laterally spaced, parallel windrows.

### CROSS-REFERENCE TO A RELATED APPLICATION

This application claims the benefit of provisional patent application U.S. App. No. 63/373,524, filed on Aug. 25, 2022 and entitled “Stalky Crop Harvesting System and Method”, the entire contents of which are hereby expressly incorporated by reference into the present application.

### BACKGROUND OF THE INVENTION

### 1. Field of the Invention

The invention relates generally to agricultural crop harvesters and, more particularly, to a harvester for harvesting stalky crops having seeds at the top of the stalks.

### 2. Discussion of the Related Art

Agricultural harvesters are well known for harvesting a wide variety of crops. “Harvesting” as used herein means removing all or part of a stalky crop plant from a field, gathering the removed plant materials and, in some instances, processing the plant materials by threshing, chopping, decorticating, etc. Harvesting may involve cutting off the stalk, as is the case with soybeans, wheat, oats, and rice, or simply removing portions of the plant from the stalk, as is the case with corn where ears are removed from stalks.

Hemp has recently enjoyed an immense increase in popularity for producing useful products such as fiber for rope and twine and/or for producing seeds for use as human or animal food products. The stalks of hemp plants serve as the source of fiber, whereas seeds are located at the tops of the plants.

Hemp historically was harvested only for its fibers and was harvested by hand or, in some cases, by sickle cutters or cutting bars that merely cut off the stalk near the base. The cut plants then were subject to post-cutting gathering, either manually or by an agricultural rake. These harvesting processes are acceptable for small-scale production but not for large scale production, which is rapidly gaining popularity. Fields of dozens or hundreds of acres are increasingly common. Even hemp that is grown for fiber simply cannot be harvested economically using historical labor-intensive techniques.

Combines typically are self-propelled machines that are provided with internal processing equipment for threshing the plants or otherwise separating the grain from other parts of the plant, storing the grain in on-board hopper, and discharging residual plant materials such as cobs, husks, stalks, pods, chaff, etc.

A variety of specialized harvesting heads are available for mounting on the front of combine, with each harvesting head being tailored for harvesting a specific type of crop. Hence a “corn head” for harvesting corn is dramatically different in construction and operation than a “grain head” for harvesting soybeans or wheat. More recently, specialized harvesting heads have been proposed for mounting on combines, such as the Bish Enterprises Super crop harvester. Hemp harvesting heads typically are modified version of one of these other heads.

In addition, processing certain crops using a combine or similar harvester can seriously degrade the crop plants. For example, the stalks often are chopped or broken into small pieces that reduce the length of recoverable fibers, degrading the value of the crop. The cut stalks also are not windrowed in a manner that facilitates their subsequent handling, such as by baling. On the other hand, machines that simply cut the stalks without threshing the plants cannot recover the seeds. The seeds or “grain” therefore must be recovered manually or via a secondary operation.

The need therefore has arisen for a stalky crop plant harvesting system that cuts and gathers the entire stalks with minimal or no damage to the plants, while also recovering seeds from the plants.

The need additionally has arisen to provide a stalky crop harvesting system that harvests the stalks in a manner that facilitates baling or other handling.

### SUMMARY OF THE INVENTION

In accordance with a first aspect of the invention, one or more of these needs is met by providing a harvesting system for stalky crops, such as hemp, that can be mounted on and powered by a conventional power unit such as an agricultural combine. The harvesting system is configured with at least one of two vertically spaced harvesting heads. A “harvesting head” in this regard is a mechanism that cuts plants and transports them off the machine in a controlled manner. The upper of these two harvesting heads directs seed-bearing portions of the plant to the combine's thresher. The lower harvesting head cuts the stalks near the ground and discharges the stalks in two or more windrows for baling or other handling.

In order to increase throughput, the upper harvesting head may include a center conveyor that is configured to feed seed-bearing materials into a front end of a feeder housing of the combine. That conveyor may extend at an adjustable angle to accommodate raising and lowering of the upper head while maintaining alignment of the conveyor with the combine's feeder housing.

In order to minimize the quantity of stalks being fed through a combine while harvesting the seeds from very tall plants, the upper harvesting head may have a cutter that can be raised to more than 10 feet, and even 12 or more feet, above the ground.

The lower harvesting head may have draper belts arranged to discharge the stalks in two or more, and more typically three or more, laterally spaced, parallel windrows. In one embodiment, the lower harvesting head is configured to discharge stalks into first and second windrows located near or at the respective left and right sides of the harvesting head and a third windrow located at the center of the harvesting head. By dividing the harvested stalks into two or more windrows, the center windrow can easily clear the bottom of the combine. In addition, smaller volumes of hemp stalks are easier to bale than large volumes.

The harvesting system may also include a frame on which the upper and lower harvesting heads are mounted. The frame may be mountable on the combine via a quick-connect coupling. The upper and lower harvesting heads may be modular in nature so that either of the of the harvesting heads could be mounted on a combine or other machine and operated without the other harvesting head.

The upper harvesting head may be dimensioned to be nestable within the lower harvesting head when fully lowered, minimizing the height of the harvesting system for transport.

Also disclosed is method of harvesting stalky crop plants. The method comprises, as an agricultural combine moves along a field, cutting top, seed bearing portions of plant stalks using a cutter of a harvesting head to form cuttings, the harvesting head being mounted on the combine. Subsequent actions include directing the cuttings onto a conveyor arrangement of the harvesting head using a rotatable gathering reel located above the cutter, and, using the conveyor arrangement, conveying the cuttings downwardly and rearwardly into an inlet opening of a feeder housing of the combine. The cuttings are then conveyed through the feeder housing and into a thresher of the combine, where the cuttings are threshed.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings, in which like reference numerals represent like parts throughout, and in which:

FIG. 1 is a schematic isometric view of a combine usable with a harvesting system constructed in accordance with invention;

FIG. 2A is a side elevation view of the combine of FIG. 2, fitted with an upper harvesting head of a harvesting system constructed in accordance with the invention;

FIG. 2B is a side elevation view of a combine similar to that shown in FIG. 1, fitted with both a lower harvesting head and an upper harvesting head of a harvesting system constructed in accordance with the invention;

FIG. 3 is an isometric view corresponding to FIG. 2A and showing the connection of the combine's feeder housing to a support frame of the harvesting system;

FIG. 4 is a front isometric view of a harvesting system constructed in accordance with the present invention and usable with the combine of FIGS. 1-3;

FIG. 5 is a rear isometric view of the harvesting system;

FIG. 6 is a front elevation view of the harvesting system;

FIG. 7 is a rear elevation view of the harvesting system;

FIG. 8 is a top plan view of the harvesting system;

FIG. 9 is a bottom plan view of the harvesting system;

FIG. 10 is a left-side elevation view of the harvesting system of the harvesting system;

FIG. 11 is a right-side elevation view of the harvesting system; and

FIG. 12 is a sectional side elevation view taken through the center of the harvesting system.

### DETAILED DESCRIPTION

Referring initially to all views, a harvesting system 20 is illustrated that is configured to harvest stalky plants having seed bearing upper ends. Such crops include, but are not limited to, hemp, sorghum, and beans. The harvesting system 20 is shown as mounted on a conventional combine 200. However, at least the lower harvesting head could be mounted on other power units as well, such as an agricultural tractor. The system 20 includes a main support structure or frame 22, an upper harvesting head 24 mounted on the frame 22, and a lower harvesting head 26 mounted on the frame 22 beneath the upper harvesting head 24. The frame 22 is mounted on a combine 200 via a quick connect coupling.

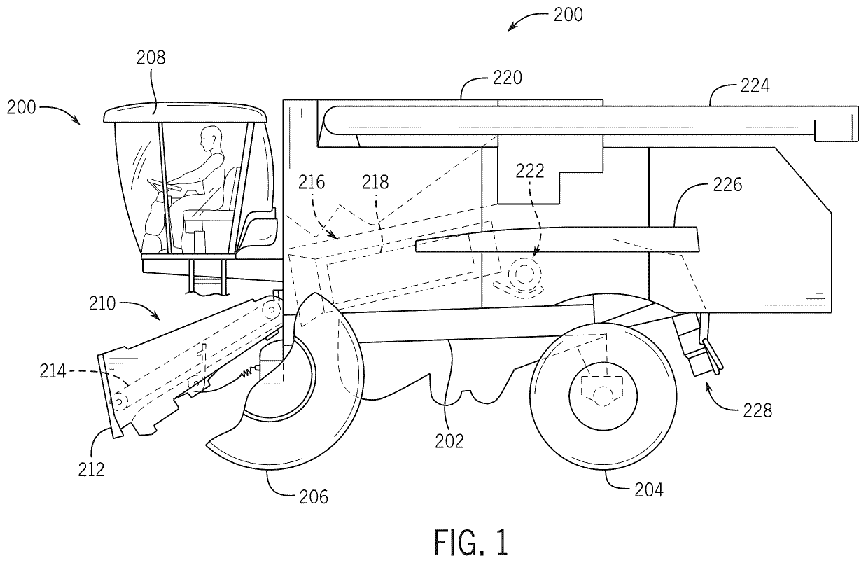

Referring to FIGS. 1-3, the combine 200 may be any combine that is commercially available from any of a number of manufacturers such as John Deer & Co. or CNH, Inc. As is typical, combine 200 comprises a chassis 202 supported on rear and front ground engaging wheels 204 and 206. Motive force to some or all of the wheels is provided by a prime mover (not shown), such a as diesel engine. This prime mover also supplies power to a hydraulic system including a pump and hydraulic cylinders; an electrical system including controllers, sensors, operator interfaces, etc.; as well as to mechanical drives such as power take offs, belts, chains, etc. An operator's cab 208 is mounted on the front of the chassis 202. A feeder housing 210 extends forwardly from the center of the front of the chassis 202. The feeder housing 210 is mounted on the chassis 202 so as to be pivotable about a horizontal axis under power of hydraulic cylinders (not shown) to raise and lower the front end of the feeder housing 210. The feeder housing 210 has a mounting structure 212 at its front end, such as a quick connect coupling, for connection to a harvesting head or, in the case of the present invention, a harvesting system.

The operational components of the combine 200 include an internal conveyor 214 in the feeder housing 210 and a crop processing system 216. As is typical, harvested crops are conveyed to the crop processing system 216 by the conveyor 214 and processed by a thresher 218 and other components of the crop processing system 216 to separate the grain from chaff, pods, etc. The grain is then conveyed to a hopper 220 by a conveyor arrangement including an auger 222, and is ultimately transferred to a truck or wagon by a discharge auger 224. Residue materials or simply “residue” in the form of straw, chaff, etc. is conveyed rearwardly away from the crop processing system 216 by a residue handling system 226, where it is processed by a processor 228, such as a chopper or spreader, before being discharged onto the ground.

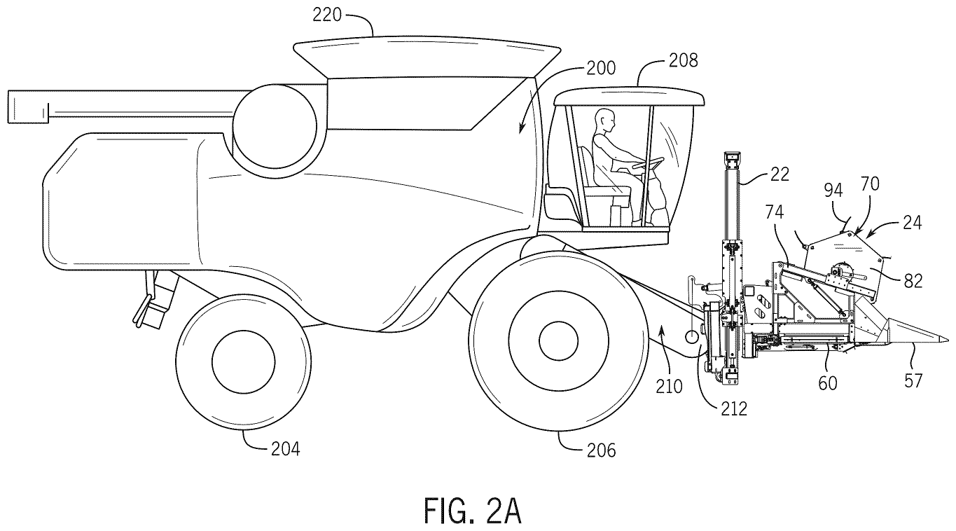

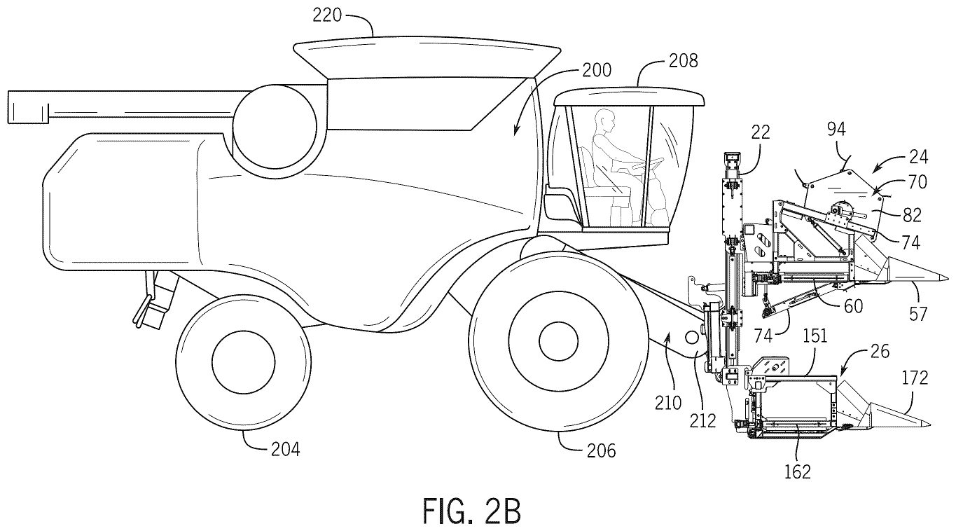

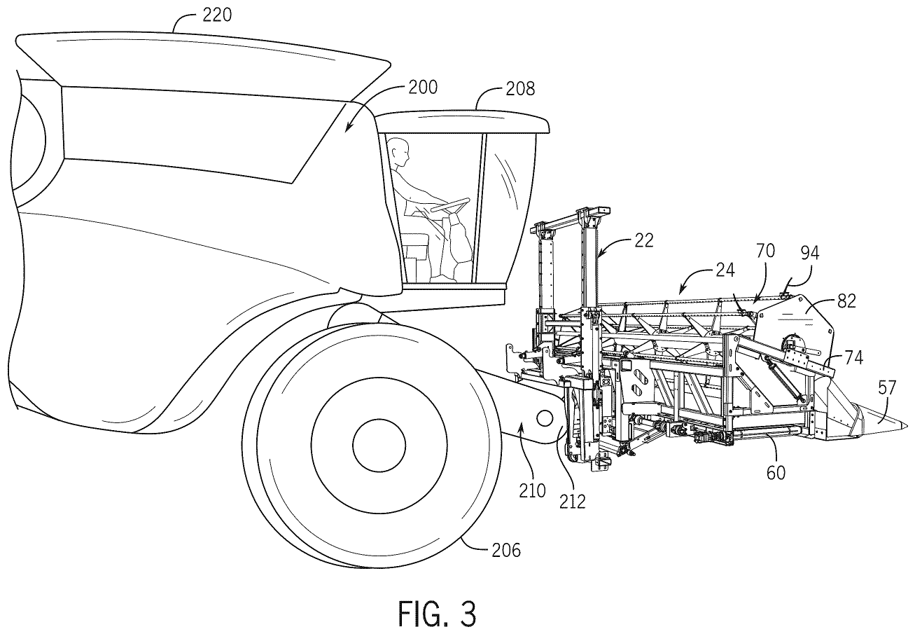

FIGS. 2A and 3 show a harvesting system mounted on the combine 200 with only one harvesting head 24. This highlights the fact that the harvesting heads 24 and 26 can be used independently of one another. In contrast, FIG. 2B shows both harvesting heads 24 and 26 mounted on the combine 200.

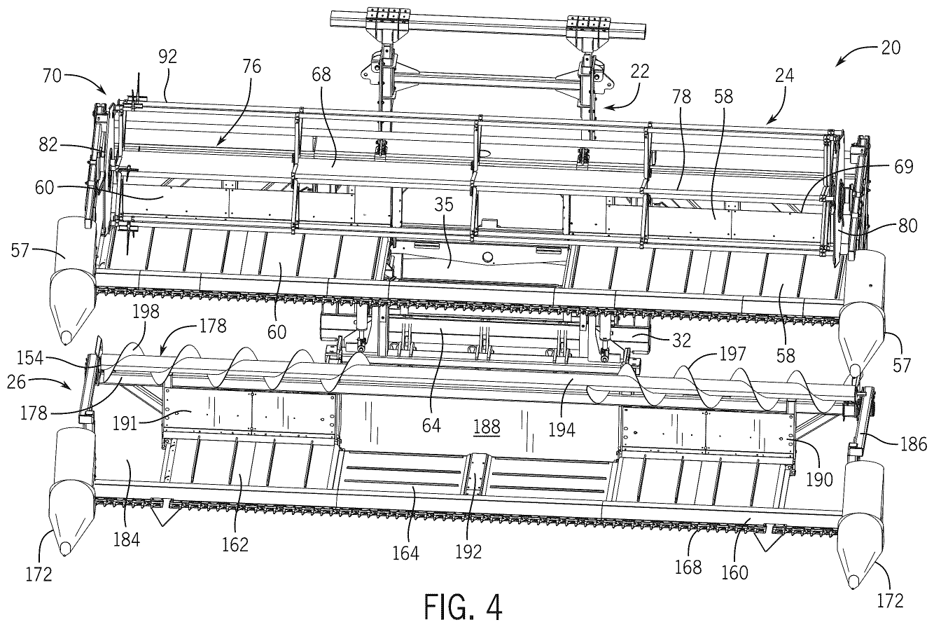

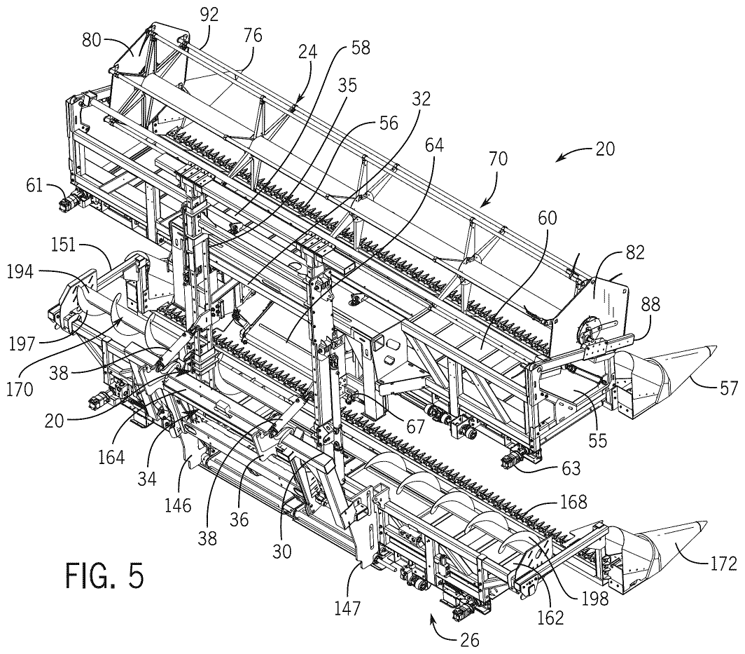

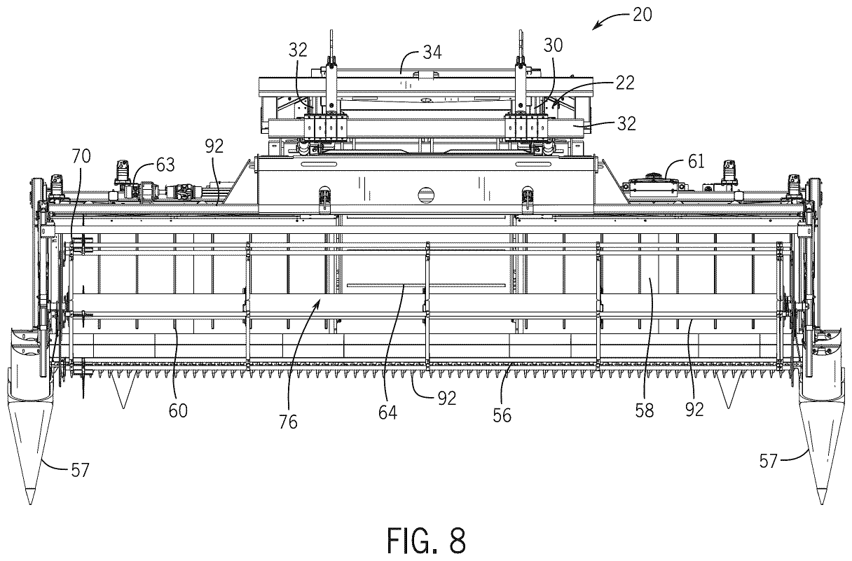

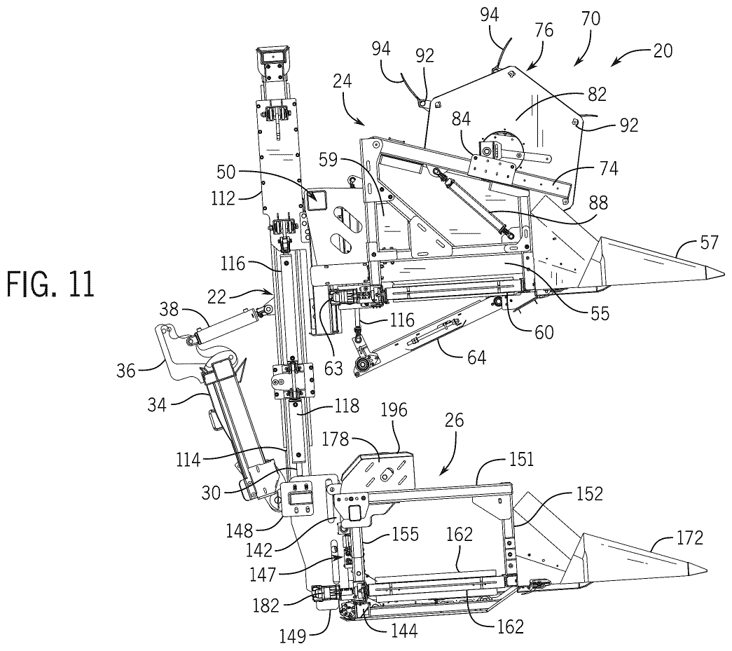

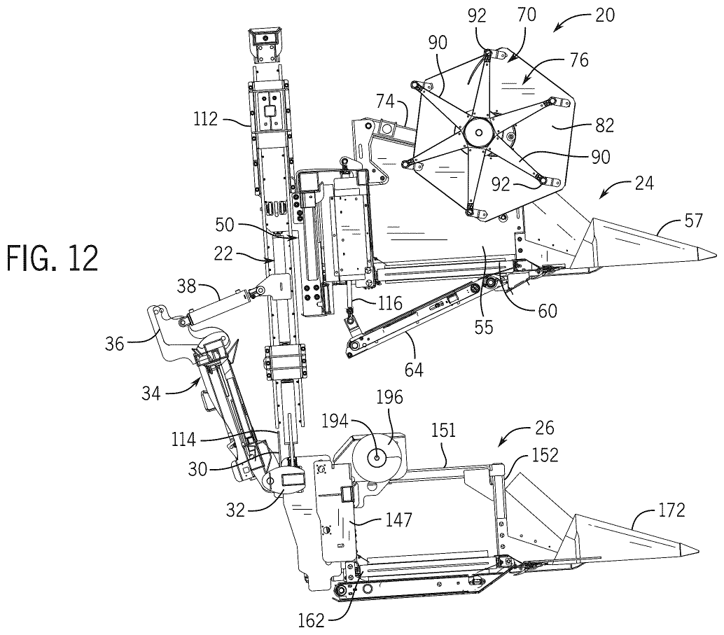

Referring now to FIGS. 4-12 and to FIGS. 4 and 10-12 in particular, the frame 22 is generally rectangular in shape. It is formed from a number of interconnected beams 30 and horizontal cross beams 32 defining a central opening 35. A mounting assembly 34 is mounted on the rear of the frame 22. The mounting assembly 34 includes a portion 36 of a quick connect coupling that can be used to mount the frame 22 on the mounting structure 212 on the front end of the feeder housing 210. If necessary, an adapter may be provided to mate the mounting structure 212 with a particular feeder housing 210. The orientation of the frame 22 can be adjust relative to the mounting assembly 34 by hydraulic cylinders 38 extending between the mounting assembly 34 and the vertical beams 30 of the frame. This adjustment permits the frame 22 to remain vertical despite changes in inclination of the feeder housing 210 as the feeder housing 210 is raised and lowered.

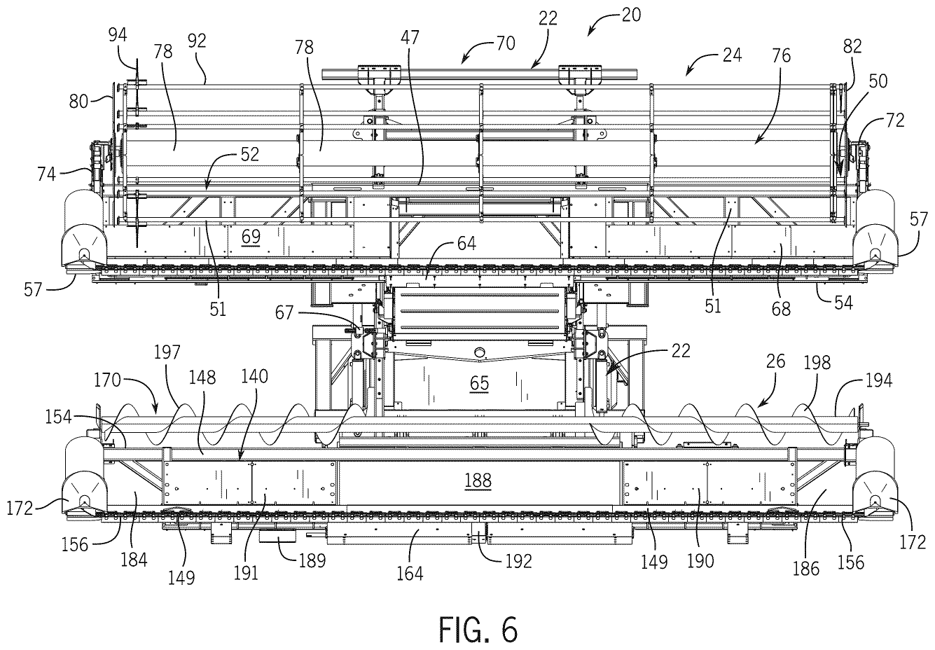

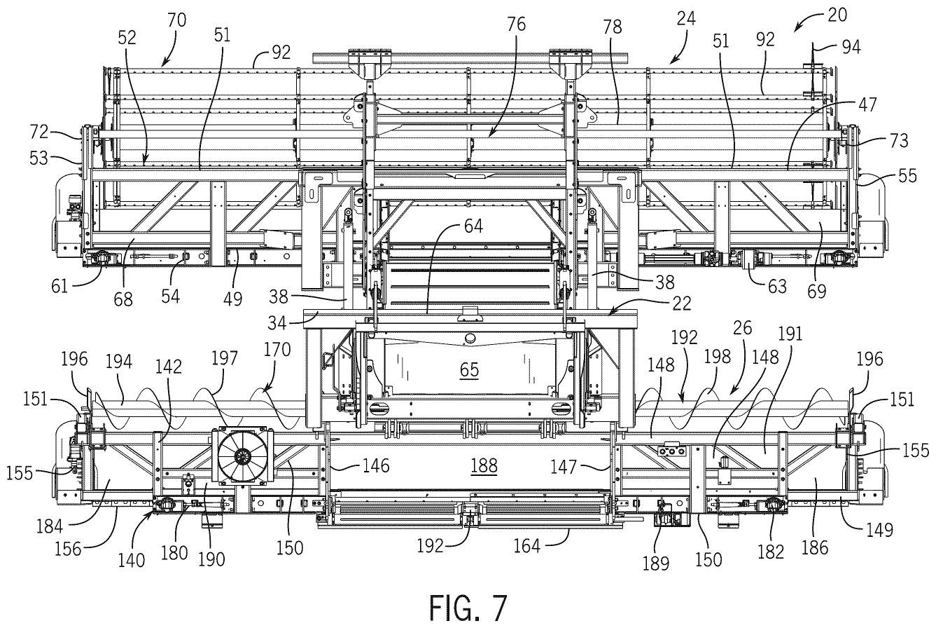

Referring again to FIGS. 4-12, the upper harvesting head 24 is a reel-type harvesting head extending transversely of the harvesting system 20. It may be generally of the type used to harvest grain, but ideally is adapted to cut off the tops of very tall plants. Harvesting head 24 may have a cutting swath of more than 14 feet, more than 20 feet, and even of 25 feet or more. It has a cutting swath of 20 feet in the present embodiment. Referring to FIGS. 6 and 7, the harvesting head 24 includes a frame 50 having a vertical rear portion 52 and a horizontal portion 54 extending forwardly from the bottom end of the vertical portion 52. The rear portion 52 includes an upper and lower cross beam 47 and 49 connected to one another by struts 51. Referring to FIGS. 6, 7, and 10-12, generally trapezoidal plates 53 and 55 and associated support tubes 59 are mounted on the opposed ends of frame 50 above the horizontal portion 54. The rear portion 52 is mounted on a carriage 102 which, in turn, is movable vertically of the frame 22, as described below. The front portion 54 supports a sickle cutter 56 at its front end and first and second (left and right) horizontal draper belts 58 and 60 behind the sickle cutter 56. The knives of the sickle cutter 56 are driven to reciprocate by a hydraulic or electric motor (not shown). Conical deflectors or snouts 57 are mounted on fronts of the plates 53 and 55 of the frame 50 and serve to guide stalks either into or away from the harvesting head 24 (depending which side of the snout 57 they are located).

Still referring to FIGS. 4-12, the draper belts 58 and 60 are aligned with one another extend longitudinally horizontally of the harvesting head 24. The belts 58 and 60 are driven to move in opposite directions by respective motors 61 and 63 so as to each convey materials toward the center of the harvesting head 24. Each draper belt 58, 60 typically is about 24″ wide. In the case of a 20 foot long harvesting head 24, each draper belt may be about 8-9 feet long, leaving a gap of between two and four feet between them. A discharge conveyor 64 is positioned in this gap. The discharge conveyor 64 comprises a draper belt that is inclined downwardly from a front end located generally in-line with the front edges of the draper belts 58 and 60 to a rear end opening into a front end of a telescopic chute 65. The inclined conveyor may be driven by a hydraulic motor or mechanically, such as by a PTO via a driveshaft 67. The rear end of the telescopic chute 65 opens into the front opening of the feeder housing 210. The telescopic chute 65 is formed of a relatively low-friction material, such as UMHW, to inhibit plugging. Vertically extending guard plates 68 and 69 are positioned behind the draper belts 58 and 60 to prevent materials from falling off the rear edges the draper belts 58 and 60.

A gathering reel assembly 70 is mounted on opposed inclined support arms 72 and 74 of the frame 50 above the sickle cutter 56 and the draper belts 58 and 60. The gathering reel assembly 70 includes a reel 76 having a center rotating hub or shaft 78 mounted on a pair of hexagonal support plates 80 and 82. The support plates 80 and 82 are pivotably but eccentrically mounted on sleeves 83 and 84 that, in turn, are mounted on support arms 72 and 74. The support plates 80 and 82, and thus the reel 76 as a whole, can be raised and lowered by hydraulic cylinders 86 and 88, each of which is connected to a respective support plate 80 or 82 and a respective hexagonal support plate 53 or 55. The reel 76 additionally includes a number of spider support elements 90, longitudinally extending bat tubes 92, and tines 94 mounted on the bat tubes 92. In operation. reel rotation causes the tines 94 to gather cut materials and direct them rearwardly onto the conveyors 58, 60 and 64.

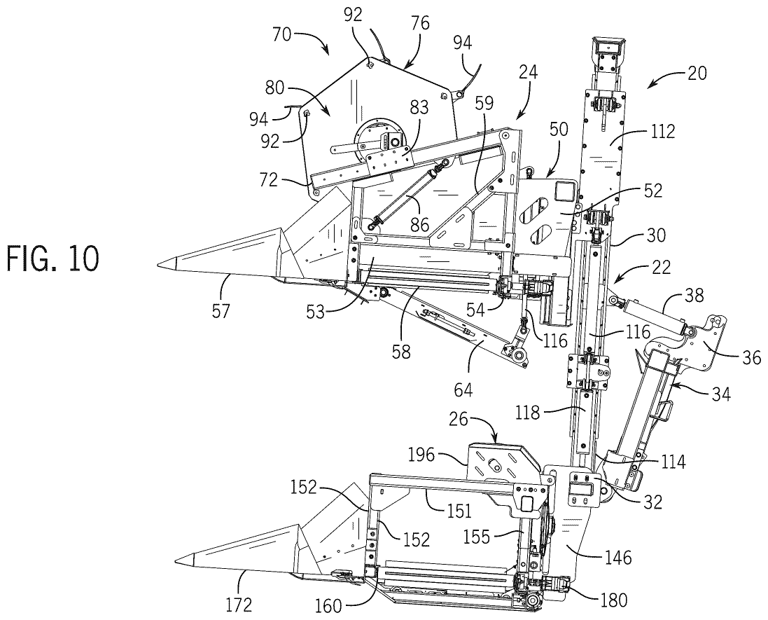

The position of upper harvesting head 24 is vertically adjustable relative to the frame 22 in order to accommodate crops of significantly different heights. In this embodiment the rear 52 of the frame 50 is mounted on a carriage 110 so as to vertically movable along the frame 22 as best seen in FIGS. 4 and 10-12. The carriage 110 comprises opposed linear bearings 112 that are slidably mounted on respective beams 114 of a mast of the frame portion 52 as best seen in FIGS. 10-12. The carriage 110 is driven vertically along the beams by hydraulic cylinders located on opposite sides of the harvesting head 24. In the present embodiment, two cylinders 116 and 118 are located on each side of the harvesting head 24, with one cylinder 116 pulling the carriage 110 from above and other 118 pushing the carriage from below. The range of vertical movement achieved by extension and retraction of the hydraulic cylinders 112 and 114 may on the order of more than six feet and, more typically, ten to twelve feet in order to permit the upper harvesting head 24 to be raised from a transport position in which it is nested withing the lower cutting head 26 for transport to a cutting height (as defined by the height of the sickle cutter 56) as high as 12 feet above the ground. This movement is accommodated by the inclined conveyor 64 and the telescoping chute 65. Specifically, a hydraulic cylinder 116 is actuated in concert with actuation of the hydraulic cylinders 112 and 114, to change the inclination angle of the conveyor 64 maintain alignment with the rear discharge end of the conveyor 64 with the inlet of chute 65. In the illustrated embodiment, the discharge conveyor 64 is inclined at an angle of 0 degrees when the upper harvesting head 24 is fully lowered to 45 degrees when the upper harvesting head 24 is fully raised. The chute 65 is coupled to the discharge conveyor 64 so as to extend and retract with raising and lowering of the discharge conveyor 64.

Referring to FIGS. 4-12, the lower harvesting head 26 is of the same cutting swath as the upper harvesting head (twenty feet in this example). However, its overall footprint is larger than that of the upper harvesting head 24 to permit nesting of the harvesting heads 24 and 26 as discussed above. The lower harvesting head 26 is configured to cut off stalks close the ground and to deposit the cut stalks on the ground in parallel windrows. The lower harvesting head 26 includes a frame 140 having a vertical rear portion 142 and a horizontal portion 144 extending forwardly from the bottom end of the vertical portion 142. The rear portion 142 includes opposed vertically extending support arms 146 and 147, each of which is rigidly, but removably, attached to the frame 22. The vertical rear portion 142 also has an upper cross beam 148 that is affixed to the upper ends of the support arms 146 and 147 and that extends the length of the harvesting head 26. A plurality of struts 150 interconnect the upper cross beam 148, the support arms 146 and 147, and a lower cross beam 149. Front and rear support posts 152 and 155 extend vertically upwardly from respective ends of the horizontal portion 144 of frame 140, and a horizontal support tube 151 extends horizontally between the upper ends of the support posts 152 and 155. Conical deflectors or snouts 172 extending forwardly from the front posts 152.

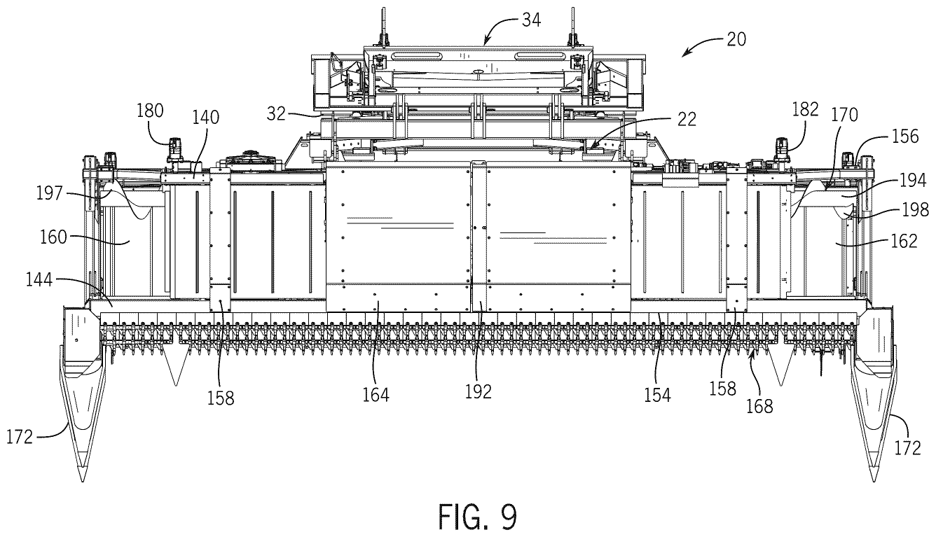

Still referring to FIGS. 4-12, the lower frame portion 144 includes front and rear longitudinally extending horizontal beams 154 and 156 linked by lateral cross beams 158 (FIG. 9). Supported on this frame 140 are first through third draper belts 160, 162, 164, a sickle cutter 168 located above and in front of the draper belts, and an auger 170 located above the rear portion of the draper belts behind the sickle cutter 168.

Referring especially to FIGS. 4, 6, and 10-12, the sickle cutter 168 is positioned less than one foot, and more typically about six inches, off the ground in order to cut as much of the stalks as possible. This cutting height can be adjusted by raising and lowering the infeed housing 210 of the combine 200. The knives of the sickle cutter 168 are driven to reciprocate by a hydraulic or electric motor (not sown). The cutting plane of sickle cutter 168 is located about 10 to 12 inches behind the cutting plane of the sickle cutter 56 of the upper harvesting head 24 so that, in operation, the upper harvesting head 24 cuts the tops off the plants before the lower harvesting head 26 cuts the stalks.

Referring now to FIGS. 4, 8, and 9, the first and second draper belts 160 and 162 are aligned with respect to one another and are disposed symmetrically relative to lateral centerline of the harvesting head 26. Each draper belt 160, 162 is positioned horizontally and extends longitudinally of the lower harvesting head 26 from an inner end to an outer end thereof. Each draper belt 160, 162 is sufficiently wide to accommodate large, bushy materials. That width may be about 30-48 inches and, more typically, 40 inches. Each belt 160, 162 may be about 3-4 feet long. Stationary guard plates 190 and 191 are located behind the draper belts 160 and 162 to prevent cut materials from falling off the rear edges of the draper belts. The draper belts 160 and 162 are driven in opposite directions by respective motors 180 and 182 so as to each discharge materials toward a respective longitudinal end of the harvesting head 26. Left and right openings or gaps 184, 186 are formed between the outer ends of the draper belts 160 and 162 and the associated ends of the harvesting head 26 to define areas where materials being conveyed by the belts 160 and 162 are discharged in respective windrows during harvesting machine operation. Each of these gaps 184 and 186 may be about 2-4 feet wide as measured from the end of the respective draper belt to the associated end of the harvesting header 26. Another gap 188 is formed centrally of the lower harvesting head 26 between the inner ends of the draper belts 160 and 162. That gap 188 may be on the order of 6-8 feet long and, more typically, seven feet. The third draper belt 164 is located in this gap and extend rearwardly from a front end aligned with the front edges of the draper belts 160 and 162 to a rear, discharge end located behind the inner edges of the draper belts 160 and 162. The discharge end of draper belt 164 opens into opening 35 in the frame 22 so that materials discharged from the draper belt 164 form a third windrow located centrally of the combine 200. The center draper belt 164 may be about seven feet wide by three feet long. It is driven by an electric or hydraulic motor 189. The belt 164 may be segmented into two parallel belts that are driven together, with the gap between the belts being covered by a guard 192. In operation, materials tend to accumulate on one side or the other of the guard 192, so that the center windrow, in effect, forms two adjacent windrows.

Referring especially to FIGS. 4, 6, and 7, the auger 170 extends horizontally longitudinally of the lower harvesting head 26 at a location above the rear edge portions of the draper belts 160 and 162. It may be located about 3-6 feet above the draper belts 160 and 162. Auger 170 includes a tube or shaft 194 driven by a hydraulic or electric motor (not shown). The shaft 194 has opposed ends, each of which is mounted on a respective support plate 196. Each support plate 196 is, in turn, are mounted on the rear end portion of a respective horizontal support tube 151. Helical flights 197 and 198 of opposite pitch are provided on the end portions of the shaft 194 over the draper belts 160 and 162, respectively, to cause materials falling against them to lay down onto the draper belts 160 and 162.

It should be noted that the harvesting system 20 is engineered to minimize its weight so as not to unacceptably move the center of mass of the combine forward. Contributing factors to weight management include, but are not limited to, the design of a relatively rigid frame and the use of relatively high strength steel for structural components. The total weight of the describe and illustrated 20 feet harvesting system is less than 5000 lbs. and, more typically, 4,500 lbs. or less.

In operation, the harvesting system 20 is mounted on the feeder housing 210 of a combine 200 using the mounting assembly 34 including the quick mount coupling. Mechanical, hydraulic, and electric connections (not shown) also are made at this time. During this process, the chute 65 is positioned such that its lower opening is positioned within the front opening of the feeder housing 210 of combine 200. To prepare for a harvesting operation, the feeder housing 210 is lowered to a position in which the sickle cutter 168 is located to within about 6 inches of the ground, and the cylinders 38 are actuated as required to ensure that the horizontal portions of the harvesting heads 24 and 26 remain parallel to the ground as the feeder housing 210 pivots. The cylinders 112 and 114 are then actuated to position the upper harvesting head 24 at a location in which the sickle cutter 56 cuts off only the seed-bearing portions of the plants. In the case of hemp, this location typically will be located 10 to 12 feet off the ground, and the sickle cutter 56 cuts off the top 12-18 inches of the plants. Cylinders 116 also are actuated at this time to adjust the inclination of the conveyor 64 as needed to assure that its discharge end remains aligned with the inlet of the chute 65, maximizing the effective area of opening into feeder housing 210. The chute 65 also telescopes as required to accommodate motion of the discharge end of the discharge conveyor 64.

The combine 200 then is propelled forwardly at a rate of 2-8, and more typically 4-7, mph with all components of both harvesting heads 24 and 26 operating. These are typical of combine harvesting speeds. When harvesting hemp, the hemp may be between 6 and 14 feet high and have crop density of 5000,000 to 2,000,000 plants/acre. The sickle cutter 56 engages and cuts off the upper 12-18 inches of the plants that bear the seeds, and the cut portions, or “cuttings”, are fed onto the draper belts 58 and 60 and the discharge conveyor 64 by the gathering reel assembly 70. The volume of cuttings fed into the combine and threshed therefore is minimized. This is in sharp contrast to a conventional combine reel-type harvesting head, whose maximum cutting height is about six feet, in which case the top four to eight feet of the plants would be fed into the combine 200 and subject to threshing—at a considerable loss of efficiency and increase of load on the combine. Cuttings deposited on the draper belts 58 and 60 are deposited onto the discharge conveyor 64. The gathered cuttings are then discharged into the chute 65 from the discharge conveyor 132 and thence into the feeder housing 210 of the combine 200. From there, the cuttings are fed into the thresher 218 of the crop processing system 216, where the seeds are separated from the other materials and conveyed to the hopper 220. The residue materials are then conveyed to the rear of the combine 200 and are chopped and/or spread before being deposited on the ground.

Just after the heads are cut from the plants, the sickle cutter 168 cuts the stalks of the plants off. These stalks typically are on the order of more than six feet long, and often ten feet long or longer. Relative motion between the combine 200 and the cut stalks causes the stalks to fall against the auger 178, which guides them laterally so that the fall onto one of draper belts 160, 162, and 164. Stalks falling onto the end belts 160 and 162 are discharged into the end gaps 184 and 186 of the lower harvesting head 26 to form first and second windrows located beyond opposed sides of the combine. Stalks falling onto the center belt 164 are discharged through the center opening in the frame 22 to form a third windrow (or two windrows located side-by-side depending on the effects of the guard 192) located under the center of the combine. Discharging these stalks into multiple windrows assures that the center windrow is low enough to provide clearance beneath the combine. Discharging the stalks in this manner also maintains the volumes of materials in each windrow manageable for handling by a conventional bailer. Since the stalks are on the order of 4-12 feet long, longer fibers can be recovered during decortication that could be recovered if the stalks were recovered after passing through the thresher of a combine.

Additional aspects of the present embodiments of the invention can be ascertained from the drawings collectively attached as the APPENDIX, which expressly form part of this application.

While the invention is described herein in connection with specific embodiment(s), it will be understood it is not intended to limit the invention to these embodiment(s). On the contrary, it is intended to cover all alternatives, modifications and equivalents as may be included within the spirit and scope of the invention as defined by the appended claims.

For example, as mentioned above, the harvesting heads 24 and 26 need not be used together. For example, harvesting head 26, or a variation of it, could be used alone if there is no desire to separate seeds from the cut stalks. In this case, the harvesting head could be operated by a tractor or similar relatively expensive prime mover rather than an expensive combine. Conversely, for shorter plants and/or plants having stalks that are of relatively small volumes, the harvesting head 24, or a variation of it, could be mounted on the lower portion of the frame 22, and the entire plant could be cut and fed through the thresher of a combine. Such a configuration is shown in FIGS. 2 and 3.

As another example, another cutter may be provided one of the harvesting heads 24 or 26 beneath the cycle cutter 56 in general vertical alignment with the sickle cutter 168 so as to cut the stalks into two sections in order to facilitate their conveyance using the belts 160, 162, and 164.

The scope of these and other changes will become apparent from the appended claims.

I claim:

1. A harvesting system comprising:
(A) a main support structure that is configured to be mounted on an agricultural combine;
(B) a harvesting head that is supported on the main support frame and that is configured to be powered by the combine, the harvesting head including
(1) a frame mounted on the main support structure and having front and rear ends and left and right ends;
(2) a cutter mounted on the frame and extending between the left and right ends of the frame in the vicinity of the front end of the frame;
(3) a rotatable gathering reel mounted on the frame above the cutter;
(4) a conveyor arrangement mounted on the frame behind the cutter and underneath the reel and extending between the left and right ends of the frame, the conveyor arrangement including a discharge conveyor, that is inclined downwardly and rearwardly relative to the frame and that is configured to convey materials into an inlet opening of a feeder housing of the combine.

2. The harvesting system of claim 1, wherein the conveyor arrangement further comprises first and second draper conveyors which are disposed on opposite sides of the discharge conveyor and which are configured to feed materials onto the discharge conveyor.

3. The harvesting system of claim 2, wherein the frame of the harvesting head is vertically movable relative to the main support structure, and wherein the inclination of the discharge conveyor is adjustable so as to retain the discharge conveyor in general alignment with the feeder housing upon vertical movement of the frame of the harvesting head relative to the main support structure.

4. The harvesting system of claim 3, further comprising a chute that has an inlet end located adjacent a discharge end of the discharge conveyor and that has an outlet configured to discharge materials into the feeder housing of the combine, wherein the chute is configured to telescope with movement of the discharge end of the discharge conveyor relative to the main support structure.

5. The harvesting system of claim 1, wherein the harvesting head is an upper harvesting head, and further comprising a lower harvesting head mounted on the main support structure beneath the upper harvesting head, the lower harvesting head including
(A) a frame mounted on the main support structure and having front and rear ends and left and right ends;
(B) a cutter mounted on the frame and extending between the left and right ends of the frame in the vicinity of the front end of the frame;
(C) a conveyor arrangement mounted on the frame behind the cutter and configured to discharge cut materials deposited onto the conveyor arrangement in plural parallel windrows.

6. The harvesting system of claim 5, wherein the convenor arrangement includes first and second draper belts that are configured to discharge materials off opposed end portions of the lower harvesting head to form first and second windrows.

7. The harvesting system of claim 6, wherein the first and second draper belts are aligned with one another, and wherein the conveyor arrangement includes a third draper belt which is positioned between the first and second draper belts and which is configured to deposit materials in a third windrow positioned between the first and second windrows.

8. The harvesting system of claim 5, further comprising an auger located over the conveyor arrangement and configured to direct cut materials onto the conveyor arrangement.

9. The harvesting system of claim 1, wherein the harvesting system weighs less than 5,000 lbs. and, more typically, less than 4,500 lbs.

10. A harvesting head that is configured to be mounted on and controlled by an agricultural combine, comprising:
(A) a frame that is configured to be mounted on the combine;
(B) a cutter mounted on the frame and extending between the left and right ends of the frame in the vicinity of a front end of the frame;
(C) a rotatable gathering reel mounted on the frame above the cutter; and
(D) a conveyor arrangement mounted on the frame behind the cutter and underneath the reel and extending between the left and right ends of the frame, the conveyor arrangement, including a discharge conveyor, that is inclined downwardly and rearwardly relative to the frame and that is configured to convey materials into an inlet opening of a feeder housing of the combine.

11. The harvesting head of claim 10, wherein the conveyor arrangement further comprises first and second draper conveyors which are disposed on opposite sides of the discharge conveyor and which are configured to feed materials onto the discharge conveyor.

12. The harvesting system of claim 11, wherein the frame of the harvesting head is vertically movable relative to the combine, and wherein the inclination of the discharge conveyor is adjustable so as to retain the discharge conveyor in general alignment with the feeder housing upon vertical movement of the frame of the harvesting head relative to the combine.

13. The harvesting system of claim 12, further comprising a chute that has an inlet end located adjacent a discharge end of the discharge conveyor and that has an outlet configured to discharge materials into the feeder housing of the combine, wherein the chute is configured to telescope with movement of the discharge end of the discharge conveyor relative to the combine.

14. A harvesting head that is configured to be supported on and powered by a power unit, the harvesting head comprising:
(A) a frame that is configured to be supported on the power unit and that has front and rear ends and left and right ends;
(B) a cutter mounted on the frame and extending between the left and right ends of the frame in the vicinity of the front end of the frame,
(C) a conveyor arrangement that is mounted on the frame behind the cutter and that is configured to discharge cut materials deposited onto conveyor arrangement in plural parallel windrows.

15. The harvesting head of claim 14, wherein the convenor arrangement includes first and second draper belts that are configured to discharge materials off opposed end portions of the lower harvesting head to form first and second windrows.

16. The harvesting head of claim 15, wherein the first and second draper belts are aligned with one another, and wherein the conveyor arrangement includes a third draper belt which is positioned between the first and second draper belts and which is configured to deposit materials in a third windrow positioned between the first and second windrows.

17. A method of operating a harvesting system, comprising, as an agricultural combine moves along a field:
(A) cutting top, seed bearing portions of plant stalks using a cutter of a harvesting head to form cuttings, the harvesting head being mounted on the combine;
(B) directing the cuttings onto a conveyor arrangement of the harvesting head using a rotatable gathering reel located above the cutter;
(C) using the conveyor arrangement, conveying the cuttings downwardly and rearwardly into an inlet opening of a feeder housing of the combine;
(D) conveying the cuttings through the feeder housing and into a thresher of the combine; and
(E) threshing the cuttings.

18. The method of claim 17, further comprising moving a frame of the harvesting head that supports the cutter and the gathering reel vertically relative to an inlet of the feeder housing, wherein the conveying is performed via a discharge conveyor, and further comprising adjusting an inclination of the discharge conveyor so as to retain the discharge conveyor in general alignment with the inlet of the feeder housing upon vertical movement of the frame of the harvesting head relative to the inlet of the feeder housing.

19. The method of claim 17, wherein the harvesting head is an upper harvesting head and further comprising,
(A) using a cutter on a lower harvesting head, cutting off bottom portions of the stalks;
(B) directing the cut bottom portions of the stalks on to a conveyor arrangement of the lower harvesting head; and
(C) using the conveyor arrangement, discharging the cut bottom portions of the stalks into plural parallel windrows extending longitudinally of the combine.

20. The method of claim 19, wherein the discharging comprises discharging the cut bottom portions of the stalks into first, second, and third parallel windrows, the first and second windrows being disposed beyond opposed lateral sides of the combine, and the third windrow extending under the combine.
